(19) United States
(12) Patent Application Publication
(10) Pub. No.: US 2011/0209072 A1
(43) Pub. Date: Aug. 25, 2011

(54) MULTIPLE STREAM INTERNET POLL

(76) Inventor: Naftali Bennett, Haifa (IL)

(21) Appl. No.: 12/708,540

(22) Filed: Feb. 19, 2010

(51) Int. Cl. G06Q 99/00; G06F 3/048; G06F 3/01; G06Q 30/00

(52) U.S. Cl. 715/760; 715/771; 705/347

(57) ABSTRACT

A system and method for providing a poll through the Internet on a subject as a stream of opinion, preferably as a dial poll, in which multiple streams of opinion may be combined, whether for a single subject or whether for a plurality of subjects combined to form a single subject.

### FIELD OF THE INVENTION

The present invention is of a system and method for a poll through the Internet and in particular, such a system and method for a real time, live poll featuring multiple streams.

### BACKGROUND OF THE INVENTION

Polling of various types is frequently conducted through the Internet, as it enables the opinions of many users to be gathered together. Typically, such polls involve a mere translation of non-Internet polling techniques to the Internet.

One method that has not been used effectively for Internet-based polling is the dial poll. A dial poll is an opinion research tool for capturing reactions to events as they happen. In a typical dial poll, a panel of respondents or participants is selected and their demographics are captured. The participants are equipped with an instrument in the form of a dial that they hold in their hands as they watch an event or presentation. The panel members are instructed to rotate the dial to indicate their approval or disapproval of the presentation as it unfolds; in other words, the opinion collection is tied to a particular media object and the opinions given are related only to that object.

The dials are typically wireless devices communicating to a data collection device interfaced to a personal computer. The real time opinions are captured from the panel for analysis and are, in many cases, displayed as overlaid graphics over the presentation or event video.

Underlying databases of user demographic information provide for selected data views of the audience response. Extensive post event analysis is carried out by studying behavioral data associated with key elements of the presentation. Extensive demographic decomposition as well as specific segment analysis is routinely carried out. However, traditional dial poll systems require a panel of 30 to 50 participants to be recruited and brought to a central location where the specialized equipment is located. Recruiting the panel entails logistics, a staff and typically some form of compensation to each panel participant. As such, a typical dial poll, using a panel of thirty to fifty participants, can cost between fifteen to thirty thousand dollars in production costs, require specially skilled personnel, a suitable facility and specialized dedicated equipment. Thus, traditional dial polls are hampered by a small sample size, which can lead to bias and non-representative results.

### SUMMARY OF THE INVENTION

There is thus an unmet need for, and it would be highly useful to have, a system and method for providing a poll through the Internet featuring a plurality of different streams, in which each subject on which polling is conducted may optionally be one of multiple streams, which may optionally be combined to a single combined stream.

The present invention overcomes the deficiencies of the background art by providing a system and method for providing a poll through the Internet on a subject as a stream of opinion, in which multiple streams of opinion may be combined, whether for a single subject or whether for a plurality of subjects combined to form a single subject. The poll is preferably a real time, live poll. However, the stream for each subject optionally and preferably relates to a plurality of different media objects, or alternatively, preferably is not tied to any particular media object. According to other embodiments of the present invention, the stream for a subject is not related to any media object, but may optionally be related to a person, a physical object or a physical act. Non-limiting examples of physical objects include consumables of any type (food and/or beverages, whether purchased from a store or in a restaurant), appliances, clothing, or any type of brand, company, or product, and so forth. Non-limiting examples of physical acts include lectures, plays, concerts and so forth.

According to at least some embodiments of the present invention, the multiple streams provided at a plurality of different distributed, non-coordinated locations. The different locations preferably comprise a plurality of different websites, and more preferably comprise at least one non-website application. Non-limiting examples of such non-website applications include a client on a user computer, a client on a cellular telephone or smart phone, or a plug-in to a web browser to be provided on a user computer or other computational device. Preferably, multiple streams from all of these different distributed, non-coordinated locations are combined to a single poll or opinion stream.

PCT Application No. WO 2001/053922 teaches a method for conducting a distributed dial-poll, where every participant receives a specific video flow (media object), and then votes on that specific media object. Thus, this application merely teaches a method to perform traditional dial polls through remote connections through the Internet.

By contrast, the present invention, in at least some embodiments, is not related to a particular media object but rather is related to a particular subject. Multiple opinion streams may optionally be combined for a single subject; also multiple subjects may optionally be combined to form a single subject. For example, an opinion stream on a celebrity may optionally be constructed through a combination of a general rating on the celebrity, a rating on an Internet video featuring the celebrity, an article on the celebrity and so forth. Preferably, the media objects are provided through the Internet, but one or more media objects may optionally be provided outside of the Internet, which is another difference with the above PCT application. Also the present invention is not limiting to media objects, as physical objects and/or acts may optionally be included as subjects for opinion streams.

In other words, the present invention no longer requires a connection between the source of media objects or experiences that influence the user (and the ability to conduct a real time vote, while the above PCT application requires such a connection in order to determine the user's opinion.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), or a pager. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows an exemplary, illustrative non-limiting system according to some embodiments of the present invention;

FIGS. 2A and 2B show exemplary, non-limiting, illustrative screen shots of the results for being displayed to users through their user computers;

FIG. 3 shows a flowchart of a non-limiting, illustrative exemplary method for opinion polling for media objects according to at least some embodiments of the present invention;

FIG. 4 shows a flowchart of a non-limiting, illustrative exemplary method for opinion polling for physical objects according to at least some embodiments of the present invention; and

FIG. 5 shows a flowchart of a non-limiting, illustrative exemplary method for opinion polling for physical acts according to at least some embodiments of the present invention.

### DESCRIPTION OF THE PREFERRED EMBODIMENTS

The present invention is of a system and method for providing a poll through the Internet on a subject as a stream of opinion, in which multiple streams of opinion may be combined, whether for a single subject or whether for a plurality of subjects combined to form a single subject. The poll is preferably a real time, live poll and is more preferably provided in the form of a dial poll.

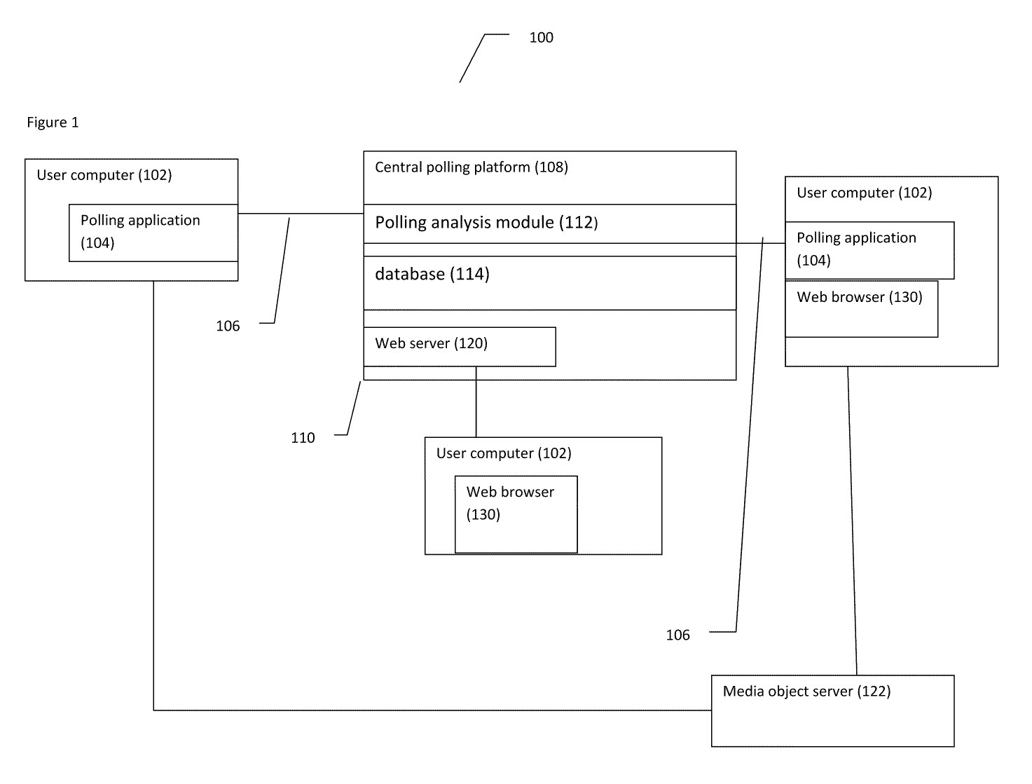

Referring now to the drawings, FIG. 1 shows an exemplary, illustrative non-limiting system according to some embodiments of the present invention. As shown, a system 100 features a plurality of user computers 102, each of which preferably operates a polling application 104. User computers 102 preferably communicate with a central polling platform 108 through a computer network 106, which is optionally and more preferably the Internet. Central polling platform 108 is optionally implemented as software, in which case central polling platform 108 is preferably operated by computer 110; hardware, firmware or a combination thereof. Again, if present, optionally computer 110 is in fact a plurality of separate computational devices or computers, any type of distributed computing platform and the like; nonetheless, a single computer is shown for the sake of clarity only and without any intention of being limiting.

Users are able to enter their opinions through polling application 104, which is optionally and preferably implemented as plug-in to a web browser 130, but which may optionally and alternatively be implemented as a stand-alone software application; both options are shown with regard to FIG. 1. Additionally or alternatively, users may optionally enter their opinions directly through a web page provided by central polling platform 108, which preferably operates a web server 120, by interacting with web browser 130 operated by user computer 102. Each of these different locations preferably supports a different opinion stream; furthermore these plurality of locations are preferably different distributed, non-coordinated locations. The different locations preferably comprise a plurality of different websites, and more preferably comprise at least one non-website application. Non-limiting examples of such non-website applications include a client on a user computer, a client on a cellular telephone or smart phone, or a plug-in to a web browser to be provided on a user computer or other computational device. Preferably, multiple streams from all of these different distributed, non-coordinated locations are combined to a single poll or opinion stream.

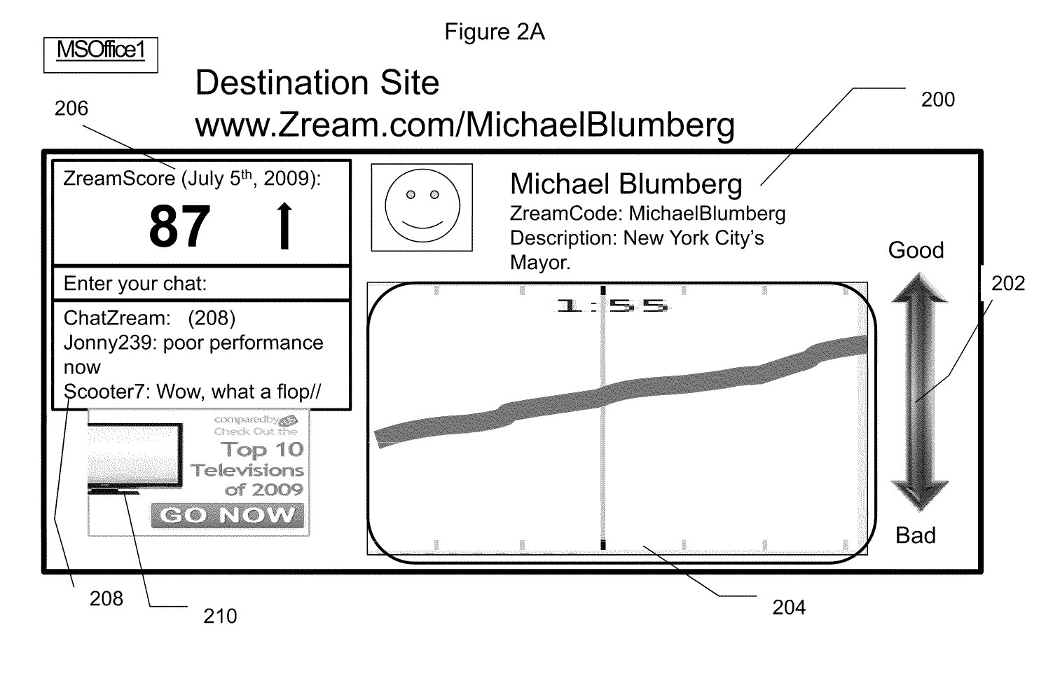

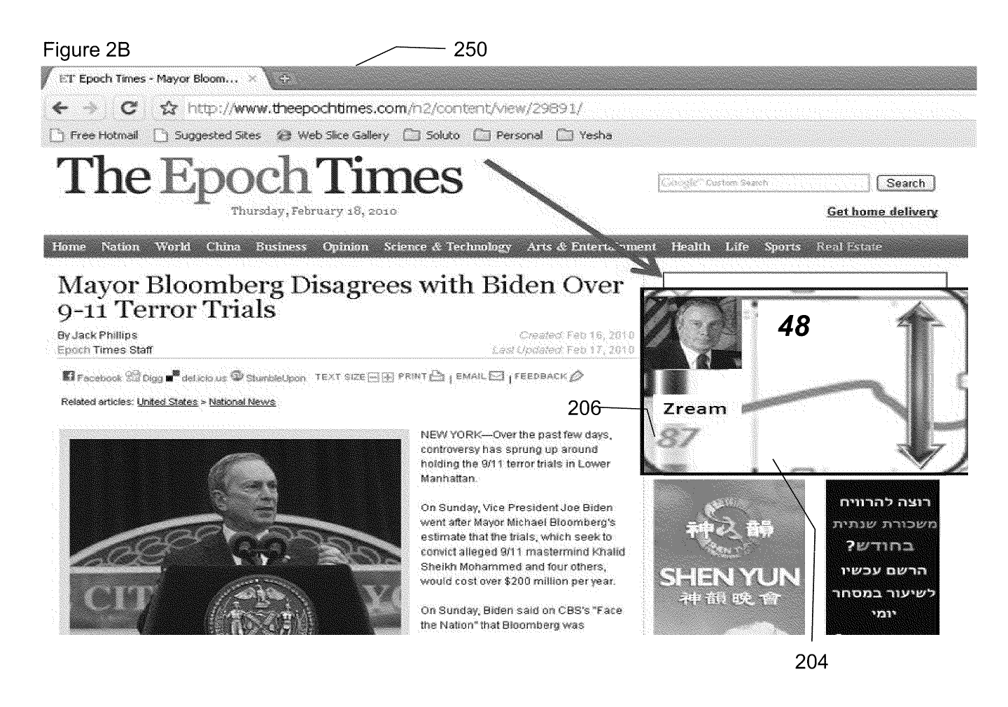

Each opinion entered is preferably entered in the form of a dial poll, as shown with regard to FIG. 2 (in a non-limiting, exemplary implementation). The opinion is preferably tied to at least one of a media object, a physical object or a physical act, or a combination thereof.

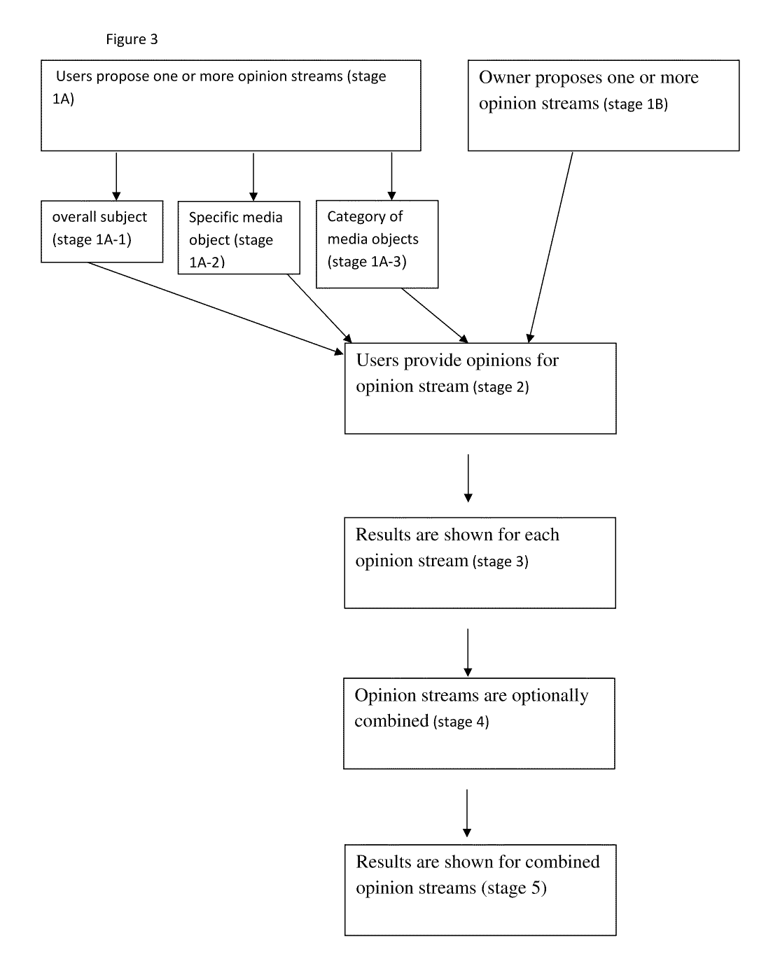

The media object is preferably any type of media item that is accessible through computer network 106, including but not limited to video, audio, a web page and the like. The media object may optionally be provided through a media object server 122, which is preferably connected to user computers 102 through computer network 106. Media object server 122 does not need to be connected to central polling platform 108, such that central polling platform 108 does not need to receive the media object or to be in connection with the media object. However optionally and preferably, central polling platform 108 may overlay a graph or other indicator on the media object. For example, central polling platform 108 may optionally communicate with media object server 122 (not shown) in order to overlay some type of indicator on the media object, and may also optionally provide a “widget” that is so overlaid, which can be accessed by user computer 102 for example. A description of a non-limiting, illustrative exemplary method for opinion polling for such media objects according to at least some embodiments of the present invention is described with regard to FIG. 3.

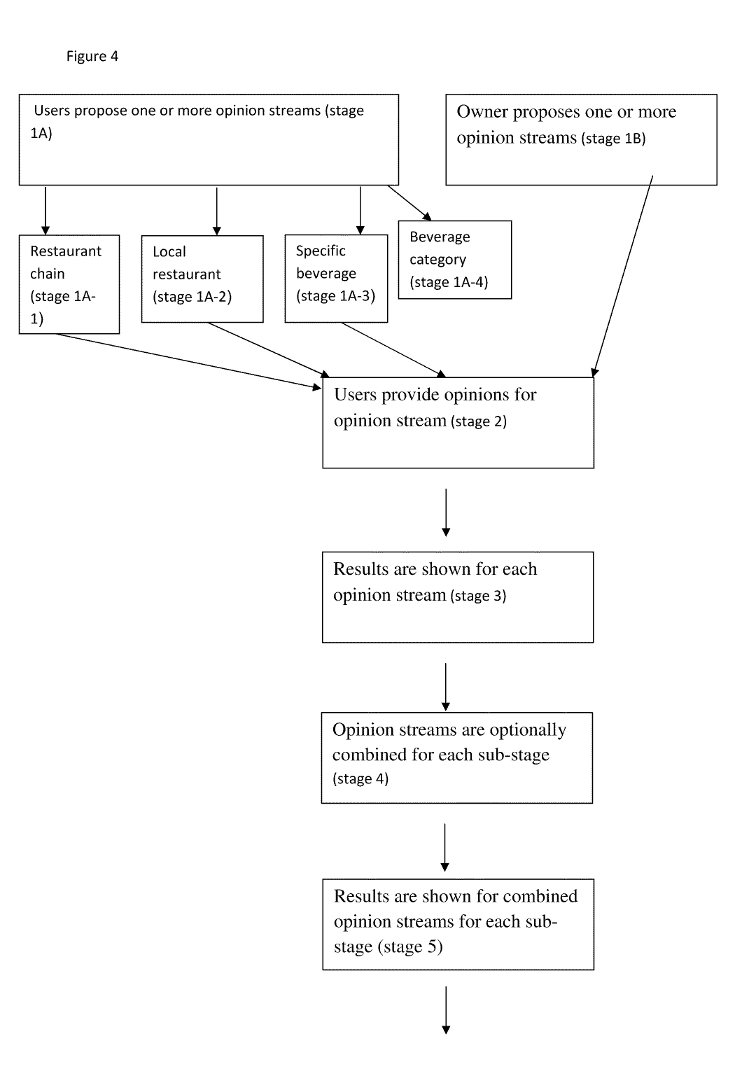

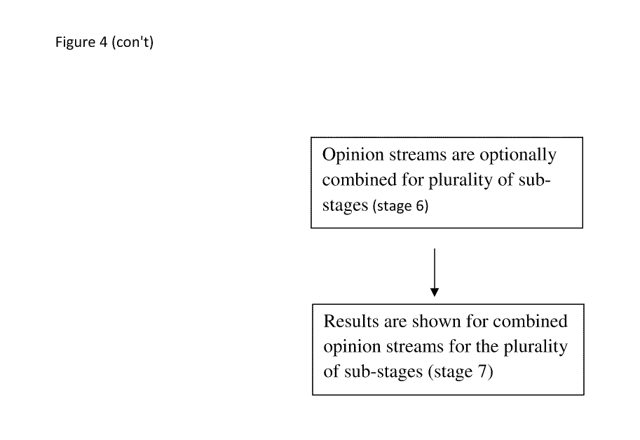

The physical object is preferably a consumable item, including but not limited to food and/or beverage; an appliance; clothing; books; software; and the like; but may optionally be any type of brand, company, or product. A description of opinion polling for such physical objects is described with regard to FIG. 4.

The physical acts include lectures, plays, concerts and so forth.

The user preferably enters the opinion through polling application 104, whether upon viewing a media object served through media object server 122, or for rating a physical object or act that is not provided through computer network 106. The opinions of multiple users are then gathered and combined into one or more opinion streams at polling analysis module 112, which preferably updates the opinion poll in real time.

Each opinion stream optionally and preferably relates to a particular subject; however, a plurality of opinion streams may optionally be combined for the particular subject. Alternatively or additionally, a plurality of subjects may optionally be combined to form a single subject, in which case the opinion streams related to each of the subjects that have been combined are preferably also combined.

Non-limiting examples are described in greater detail below with regard to the flowcharts; some examples are also given herein. For example, for a celebrity, there may optionally be multiple opinion streams and stream combinations as follows. One opinion stream may optionally relate to the celebrity himself or herself. There may optionally be multiple such opinion streams, as users preferably propose opinion streams through polling application 104. Additionally or alternatively, the celebrity himself or herself, and/or his/her agents or representatives, may also optionally propose an opinion stream related to the celebrity. Preferably such opinion streams are combined to form a single opinion stream.

Other opinion streams related to the celebrity may optionally include but are not limited to separate opinion streams regarding particular media objects (specific songs, videos, audio clips, web based articles and so forth), which may also optionally be combined for each such object if the users propose a plurality of different opinion streams for the same media object. The opinion streams may optionally be combined also by category—music, videos, films and so forth. Furthermore, the opinion streams may optionally be combined also overall for the celebrity in general, such that each opinion stream related to a specific aspect of the celebrity—whether according to categories of media objects or specific media objects—is optionally and preferably combined to form the overall opinion stream for the celebrity by polling analysis module 112.

The results of each opinion stream and also of the combination of opinion streams are preferably stored in a database 114; the results may optionally and preferably be displayed to user computers 102 through web server 120, for example for displaying the results on a web page.

FIGS. 2A and 2B show exemplary, non-limiting, illustrative screen shots of the results for being displayed to user computers 102 of FIG. 1 (not shown). As shown with regard to FIG. 2A, a results page 200 is preferably tied to a particular subject, such as a celebrity (in this case, named “Michael Bloomberg”). A poll meter 202 is shown to the right of the screen; it is preferably in the same or similar format as the poll meter presented to the user through user application 104 (not shown). The results in relation to poll meter 202 are preferably shown in a results graph 204. Results graph 204 may optionally show historical results but is preferably shown in a “live” or real time (rapidly updating) format. The rapidity of updating is optionally at least weekly, preferably daily, more preferably hourly and most preferably by minutes or even seconds. A summary of the results in a single number is preferably shown as summarized results 206.

Optionally commentary by users is shown through a chat results 208, in which the users submit messages through various formats (through a centralized website, IM (instant messenger) or other chat software, email and so forth), preferably as comments on the overall results or on particular aspects of the subject.

Also optionally an advertisement 210 is shown, which may optionally advertise results of other opinion streams and/or which may optionally advertise products and/or services, whether related or unrelated to the subject of the results page 200.

FIG. 2B shows another exemplary, non-limiting, illustrative screen shot of the results for being displayed to user computers 102 of FIG. 1 (not shown), in which the results are shown overlaid on a webpage which features a story about the person who is the focus of the opinion streams, although of course any other media object could optionally be so presented.

In this non-limiting example, a web page 250 is shown, featuring the person who is the focus of the opinion streams. Again results graph 204 is shown, which may optionally show historical results but is preferably shown in a “live” or rapidly updating format. The rapidity of updating is optionally at least weekly, preferably daily, more preferably hourly and most preferably by minutes or even seconds. Again, the summary of the results in a single number is preferably shown as summarized results 206. However, in this example, results graph 204 and summarized results 206 are shown overlaid on web page 250. Results graph 204 may also optionally feature a photograph of the subject of the opinion streams, in this case a photograph of the person who is the subject of the opinion streams. Results graph 204 and summarized results 206 are preferably the result of a combination of opinion streams from multiple different locations, including locations that are not related to web page 250, and are not limited to opinions specifically of web page 250 itself.

FIG. 3 shows a flowchart of a non-limiting, illustrative exemplary method for opinion polling for media objects according to at least some embodiments of the present invention. The opinion polling is preferably implemented as described with regard to FIG. 1, such the users preferably exclusively provide opinions through an electronic device, including any type of computer, cellular telephone, smart phone and so forth as described above. The electronic device supports an opinion interface for the user, which is preferably a GUI (graphical user interface). The electronic devices are preferably linked in an electronic device network. As shown, in stage 1A, one or more users propose a subject for an opinion stream, which includes an opinion related to at least one media object. Stage 1A is shown further subdivided into a plurality of related or sub-stages, in which opinion streams are proposed with regard to the overall subject (stage 1A-1); a particular media object associated with the overall subject (stage 1A-2); or a category of media objects associated with the overall subject (stage 1A-3). Optionally and preferably, a plurality of opinion streams may be proposed by a plurality of users for each sub-stage, even for the same general subject, specific media object or category of media objects.

Stage 1B shows another embodiment of the present invention, in which the “owner” of the general subject proposes one or more of the opinion stream for the general subject, specific media object or category of media objects related to that subject. The sub-stages are not shown but may optionally be similar or identical to those for stage 1A. By “owner” it is meant the individual or his/her representatives or agents (for a celebrity); the owner of a particular brand; and so forth. For this embodiment, optionally only one opinion stream is shown for each of the general subject, specific media object or category of media objects related to that subject. The owner may also optionally decide only to have a specific number of opinion streams related to the general subject, for example by having one opinion stream for the general subject only, without any opinion streams for a specific media object or category of media objects related to that subject.

Stages 1A and 1B may optionally be combined, in which both the owner of the general subject and one or more individual users propose opinion streams related to the same general subject or a subset thereof (for example, a specific media object or category of media objects related to that subject). However, in this case, preferably results from the owner of the general subject are shown first and/or are given greater weight in the final summation of results as shown with regard to FIG. 2.

In stage 2, a plurality of users provide their opinions for the opinion stream, according to the subject (a general subject, a specific media object or category of media objects related to that subject). Optionally, the opinions may be provided through a polling application on the user computer and/or they may be provided through a separate web page, or through any type of communication (SMS messages, instant messaging and so forth). Preferably the opinions are provided in a simple format such that a plurality of opinions may be easily combined; for example in the form of a dial poll, which may optionally take the form of a slider, showing a graduated response curve from negative to positive.

In stage 3, results are optionally shown for each opinion stream, for example as shown with regard to FIG. 2, preferably with real time updating and display, a preferred embodiment which may optionally be implemented for any application described herein.

In stage 4, optionally a plurality of opinion streams are combined that are related to the same specific media object and/or category of media objects and/or general subject. All opinion streams related to a general subject may optionally be combined, even if the opinions themselves are directed to a specific media object and/or category of media objects.

In stage 5, the combined results are optionally shown, for example as shown with regard to FIG. 2. Of course, both singular and combined results may optionally be provided.

FIG. 4 shows a flowchart of a non-limiting, illustrative exemplary method for opinion polling for physical objects according to at least some embodiments of the present invention. The opinion polling is preferably implemented as described with regard to FIG. 1, such the users preferably exclusively provide opinions through an electronic device, including any type of computer, cellular telephone, smart phone and so forth as described above. The electronic device supports an opinion interface for the user, which is preferably a GUI (graphical user interface). The electronic devices are preferably linked in an electronic device network.

As for the method of FIG. 3, optionally stage 1 may have two embodiments, which may be implemented separately or in combination, by users (stage 1A) or by the owner of the physical object (stage 1B). For this method, the different sub-stages may optionally relate to different manifestations of the physical object.

For the non-limiting example of a beverage provider which sells beverages through local restaurants that are part of a chain of such restaurants, branded by the name of the beverage provider, and also sells beverages through stores that are not branded by the name of the beverage provider (such as a supermarket for example), stage 1A could optionally have the following sub-stages. Stage 1A-1 optionally relates to the chain of restaurants; stage 1A-2 optionally relates to a local restaurant at a particular location; stage 1A-3 optionally relates to a specific beverage sold at the restaurant and/or non-restaurant store; and stage 1A-4 optionally relates to a category of beverages sold at the restaurant and/or non-restaurant store. Stage 1B may also optionally have similar sub-stages (not shown).

Stages 2 and 3 are optionally implemented as for the method of FIG. 3 for individual opinion streams. However various combinations of the opinion streams are also optionally possible, preferably according to each of the above sub-stages describing opinion streams for different manifestations of the physical object.

For example in stage 4, optionally all opinion streams related to each of the above sub-stages are combined, so that there are combination streams for the particular streams for each of the chain of restaurants; a local restaurant at a particular location; a specific beverage sold at the restaurant and/or non-restaurant store; and a category of beverages sold at the restaurant and/or non-restaurant store. In stage 5, the results are displayed to the users as previously described.

In stage 6, opinion streams from different sub-stages are optionally combined, so that for example the results of all local restaurants are optionally combined with the results for the chain of restaurants; the results for all individual beverage types are optionally combined with the opinion stream for their respective beverage category; optionally all beverage results are combined to a single opinion stream; and/or optionally all results for the brand are combined to a single opinion stream.

In stage 7, results for one or more of the above combined opinion streams are preferably displayed to the users as previously described.

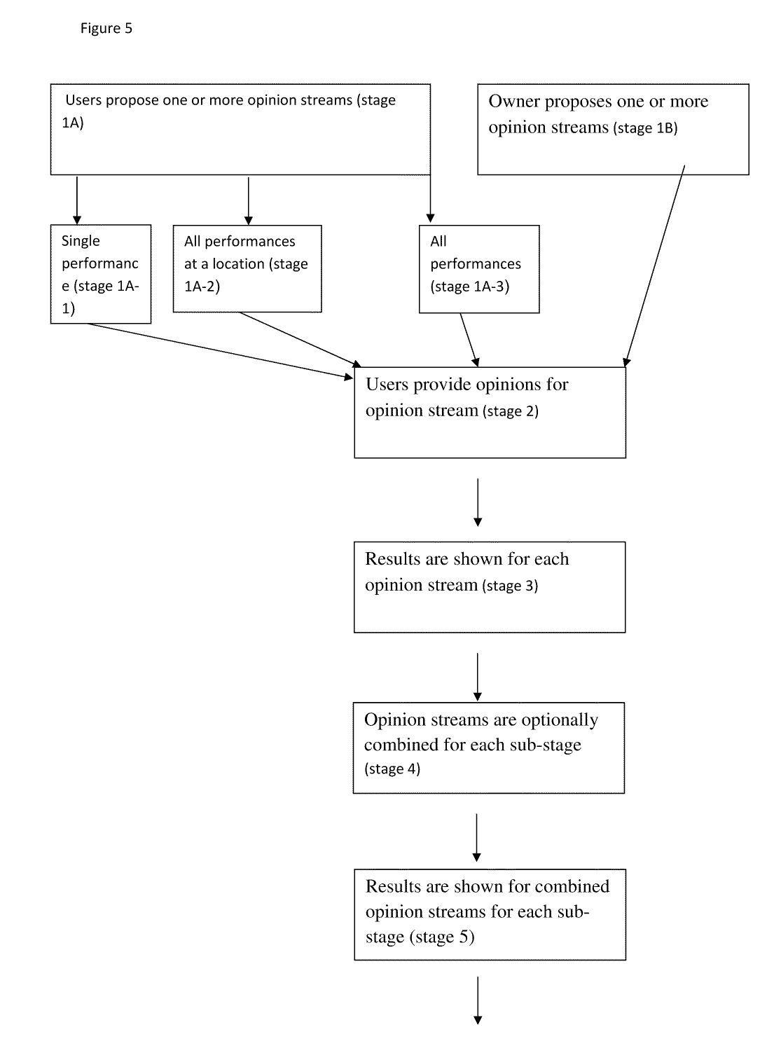

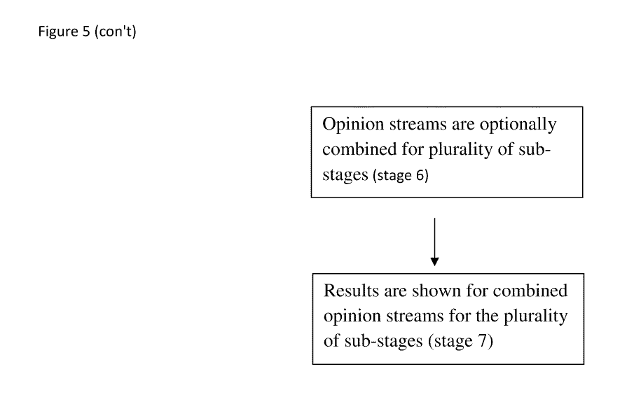

FIG. 5 shows a flowchart of a non-limiting, illustrative exemplary method for opinion polling for physical acts according to at least some embodiments of the present invention. The opinion polling is preferably implemented as described with regard to FIG. 1, such the users preferably exclusively provide opinions through an electronic device, including any type of computer, cellular telephone, smart phone and so forth as described above. The electronic device supports an opinion interface for the user, which is preferably a GUI (graphical user interface). The electronic devices are preferably linked in an electronic device network.

For this non-limiting example, the physical act is assumed to be a performance that is presented more than once at each of a plurality of locations.

As for the method of FIG. 3, optionally stage 1 may have two embodiments, which may be implemented separately or in combination, by users (stage 1A) or by the owner of the physical act, such as the performers for example (stage 1B). For this method, the different sub-stages may optionally relate to different performances, optionally including different locations, of the physical act.

For the non-limiting example of a physical act which is assumed to be a performance that is presented more than once at each of a plurality of locations, stage 1A could optionally have the following sub-stages. Stage 1A-1 optionally relates to a particular performance on a particular date; stage 1A-2 optionally relates to all performances at a particular location; and stage 1A-3 optionally relates to all performances at all locations of the tour. Stage 1B may also optionally have similar sub-stages (not shown).

Stages 2 and 3 are optionally implemented as for the method of FIG. 3 for individual opinion streams. However various combinations of the opinion streams are also optionally possible, preferably according to each of the above sub-stages describing opinion streams for different performances.

For example in stage 4, optionally all opinion streams related to each of the above sub-stages are combined, so that there are combination streams for the particular streams for each of a particular performance on a particular date; all performances at a particular location; and all performances at all locations of the tour. In stage 5, the results are displayed to the users as previously described.

In stage 6, opinion streams from different sub-stages are optionally combined, so that for example the results of all performances at a particular location are optionally combined with individual performance opinion streams at that location; and/or optionally all results for the performances at all locations are combined to a single opinion stream.

In stage 7, results for one or more of the above combined opinion streams are preferably displayed to the users as previously described.

While the invention has been described with respect to a limited number of embodiments, it will be appreciated that many variations, modifications and other applications of the invention may be made.

What is claimed is:

1. A method for providing an opinion poll on a subject through an electronic device network of a plurality of electronic devices, comprising providing an opinion interface through said electronic devices, obtaining a plurality of opinion streams through said opinion interface, wherein users provide said opinion streams exclusively through the plurality of electronic devices, wherein said opinion interface comprises a GUI (graphical user interface) and wherein said opinion streams are updated in real time, and combining said plurality of opinion streams to form said opinion poll.

2. The method of claim 1, wherein said opinion streams are related to a media object, a person, a physical object or a physical act.

3. The method of claim 2, wherein said physical objects include one or more of consumables of any type (food and/or beverages, whether purchased from a store or in a restaurant), appliances, clothing, or any type of brand, company, or product.

4. The method of claim 2, wherein said physical acts include one or more of lectures, plays, concerts and so forth.

5. The method of claim 1, wherein the subject of said opinion poll comprises a combination of one or more of a person, a media object featuring said person, a physical act performed by said person and a physical object related to said person.

6. The method of claim 1, wherein the subject of said opinion poll comprises a combination of different manifestations of a physical object.

7. The method of claim 1, further comprising proposing a new opinion stream or opinion poll by an owner of the subject or by a user through an electronic device.

8. A method for providing an opinion poll through the Internet, comprising obtaining a plurality of opinion streams provided at a plurality of different distributed, non-coordinated locations, wherein said locations comprise at least a plurality of different websites for being accessed through a computer; and determining the opinion poll according to said plurality of opinion streams.

9. The method of claim 8, wherein said opinion streams are related to a media object, a person, a physical object or a physical act.

10. The method of claim 9, wherein said physical objects include one or more of consumables of any type (food and/or beverages, whether purchased from a store or in a restaurant), appliances, clothing, or any type of brand, company, or product.

11. The method of claim 9, wherein said physical acts include one or more of lectures, plays, concerts and so forth.

12. The method of claim 9, wherein said locations further comprise at least one non-website application.

13. The method of claim 12, wherein said non-website applications comprise one or more of a client on a user computer, a client on a cellular telephone or smart phone, or a plug-in to a web browser to be provided on a user computer or other computational device.

14. The method of claim 13, wherein said determining the opinion poll further comprises combining said plurality of streams from all of said different distributed, non-coordinated locations to a single opinion stream.

15. The method of claim 14, wherein each opinion stream comprises a dial poll and wherein the method further comprises providing a dial poll interface at said plurality of locations, including at said plurality of different websites; and obtaining an opinion from a plurality of users, interacting with said different websites through a plurality of user computers, to provide an opinion through said dial poll interface.

16. A system for providing an opinion poll through the Internet, comprising a plurality of electronic devices for being operated by a plurality of users, wherein said plurality of electronic devices comprises a computer and a cellular telephone, each electronic device operating an opinion interface for receiving an opinion of the user, said opinion interface providing a dial poll; a central polling platform for receiving said opinions of said users from said electronic devices and for combining said opinions to form a combined opinion stream in real time, wherein said plurality of electronic devices and said central polling platform communicate through the Internet; and a web server in communication with said central polling platform for providing results of said combined opinion stream, wherein said results include at least a single number corresponding to results from said dial poll.

17. The system of claim 16, wherein said web server is controlled by said central polling platform.

18. The system of claim 17, wherein said opinion interface comprises a web browser for displaying said dial poll through a web page, said web page being provided by said web server.

19. The system of claim 16, wherein said opinion interface comprises a plug in to a web browser for displaying said dial poll through any web page.

20. The system of claim 16, wherein said opinion interface comprises a stand alone software application for displaying said dial poll, said stand alone software application being operated by said electronic device and communicating with said central polling platform to provide results of said dial poll.
